(19) United States
(12) Patent Application Publication
(10) Pub. No.: US 2013/0108955 A1
(43) Pub. Date: May 2, 2013

(54) PROCESS FOR PRODUCING TONER

(71) Applicant: CANON KABUSHIKI KAISHA, Tokyo (JP)

(72) Inventors: Takaho Shibata, Tokyo (JP); Masayoshi Kato, Tokyo (JP); Takashi Hirasa, Yokohama-shi (JP); Hayato Ida, Yokohama-shi (JP); Yuya Chimoto, Kawasaki-shi (JP)

(73) Assignee: CANON KABUSHIKI KAISHA, Tokyo (JP)

(21) Appl. No.: 13/655,256

(22) Filed: Oct. 18, 2012

(30) Foreign Application Priority Data
Oct. 28, 2011 (JP) 2011-236690

(51) Int. Cl. G03G 9/09

(52) U.S. Cl. 430/137.14

(57) ABSTRACT

An object of the present invention is to provide a process of producing a toner according to an emulsion aggregation process in which the temperature and treatment time in the fusion process can be reduced, and a toner having a small particle diameter, a sharp particle size distribution, and a properly controlled average circularity can be efficiently produced simply with a small amount of energy. The process includes aggregating a resin fine particles and a colorant fine particles by adding an aggregating agent containing a divalent or higher-valent metal ion, and fusing the resin fine particles and the colorant fine particles to obtain a toner particle by adding a chelating agent and a monovalent metal salt to the aggregate particle dispersion liquid obtained in the aggregation process, and heating the liquid to a temperature of not less than glass transition temperature of the resin.

### BACKGROUND OF THE INVENTION

1. Field of the Invention

The present invention relates to a process for producing a toner that can be used in electrophotographic apparatuses using an electrophotographic process such as copiers, printers, and fax machines.

2. Description of the Related Art

Currently, users in individual households, offices, and publishing fields have increasingly demanded higher quality of images in prints and copies because of rapid spread of digital techniques. In order to meet the demand for the high image quality, particularly in a toner used in the electrophotography, a technically important approach is to make the particle diameter of the toner small and improve the resolution. Currently, the weight-average particle size of the toner can be reduced to the range of a 5 μm order. Unfortunately, if particle size distribution is sufficiently controlled to produce a toner having a weight-average particle size of not more than 6 μm, such demands are difficult to meet by a kneading pulverization process used in the related art from the viewpoint of production energy and cost. For this reason, at present, processes for producing a toner using a chemical production process such as a suspension polymerization process, a dissolution suspension process, and an emulsion aggregation process are also used in which the particle size distribution and particle diameter of the toner are easy to control. Among these, the emulsion aggregation process receives attention because the shape and dispersibility of a particle can be intentionally controlled.

The emulsion aggregation process is generally a production process in which a resin fine particle obtained by an emulsion polymerization process or a phase inversion emulsion process, a colorant fine particle, and when necessary a release agent fine particle are mixed in an aqueous medium; a pH control or aggregating agent is added to aggregate the resin fine particle, the colorant fine particle, and the like and form an aggregate particle having a diameter corresponding to a toner particle diameter; and these fine particles are heated to be fused and integrated and form the fused particle into a toner particle having a controlled shape. In the fusion process for controlling a particle to have a desired toner shape, however, the particle usually needs to be treated for a long time on a high temperature condition such as a temperature approximately 30 to 40° C. higher than the glass transition temperature of a binder resin (around 100° C.). For this reason, a large amount of energy and a long treatment time are necessary (Japanese Patent Application Laid-Open No. H11-311877 and Japanese Patent Application Laid-Open No. 2001-209212). In the case where the binder resin is polyester, if the binder resin is exposed on such a high temperature condition in an aqueous medium for a long time, the binder resin may be hydrolyzed depending on the structure of polyester, resulting in insufficient blocking resistance and environmental stability of charging of the toner. As above, a fusion process that can fuse an aggregate particle at a low temperature for a short time is desired for energy reduction in the production process and suppression in alteration of the binder resin in the toner during a production step.

As a method for reducing a temperature in the fusion process in the emulsion aggregation process, a method has been proposed in which the fusion process is accelerated by using a specific aluminum complex as an aggregating agent (Japanese Patent Application Laid-Open No. H11-153883). Unfortunately, in this method, a complex of aluminum easily coordinated with an acidic polar group contained in the binder resin such as carboxylic acid is used as an aggregating agent, and therefore the aggregating agent is likely to remain in the toner. As a result, an influence of the aggregating agent may prevent desired charging properties and fixability of the toner.

Another method has been proposed in which the fusion process is accelerated by adding a specific metal powder (a transition metal such as copper and iron) or a salt thereof in the fusion process (Japanese Patent Application Laid-Open No. 2010-92055). Unfortunately, in this method, a polyvalent transition metal or a salt thereof having a strong aggregation force is added to an aggregate particle aggregated to have a toner particle diameter. For this reason, further aggregation between the aggregate particles cannot be avoided, and coarse particles are produced, leading to difficulties in production of a toner having desired particle size distribution. Moreover, because the metal powder or a salt thereof to be added is polyvalent, the metal powder or a salt thereof is likely to be coordinated with carboxylic acid in the binder resin, and remain in the toner.

### SUMMARY OF THE INVENTION

An object of the present invention is to solve the above-described problems.

Namely, an object of the present invention is to provide a process for producing a toner in which in production of a toner particle by an emulsion aggregation process, a fusion process can be performed at a low temperature for a short treatment time, and a toner particle having a small particle diameter, a sharp particle size distribution, and a properly controlled average circularity can be efficiently produced simply with a small amount of energy.

As a result of extensive research on the related art and the problems, the present inventors have completed the present invention shown below.

The present invention relates to a process for producing a toner, including the steps of:

(I) Mixing

an aqueous dispersion liquid in which resin fine particles each containing a resin having an acidic polar group are dispersed, with

an aqueous dispersion liquid in which colorant fine particles each containing a colorant are dispersed, to obtain a mixed dispersion liquid containing the resin fine particles and the colorant fine particles;

(II) aggregating the resin fine particles and the colorant fine particles to form aggregate particles by adding an aggregating agent containing a divalent or higher-valent metal ion to the mixed dispersion liquid; and

(III) fusing the resin fine particles and the colorant fine particles in the aggregate particles by
(a) adding a chelating agent to a dispersion liquid of the aggregate particles, and then adding a monovalent water-soluble metal salt thereto, and
(b) heating at a temperature of not less than a glass transition temperature of the resin having an acidic polar group.

According to the present invention, the temperature and treatment time in the fusion process can be reduced.

Moreover, a toner particle having a small particle diameter, a sharp particle size distribution, and a properly controlled average circularity can be efficiently produced simply with a small amount of energy.

Further features of the present invention will become apparent from the following description of exemplary embodiments.

### DESCRIPTION OF THE EMBODIMENTS

Preferred embodiments of the present invention will now be described in detail.

The process for producing a toner according to the present invention relates to a process for producing a toner, comprising the steps of (I) mixing an aqueous dispersion liquid in which resin fine particles each containing a resin having an acidic polar group are dispersed, with an aqueous dispersion liquid in which colorant fine particles each containing a colorant are dispersed, to obtain a mixed dispersion liquid containing the resin fine particles and the colorant fine particles; (II) aggregating the resin fine particles and the colorant fine particles to form aggregate particles by adding an aggregating agent containing a divalent or higher-valent metal ion to the mixed dispersion liquid; and (III) fusing the resin fine particles and the colorant fine particles in the aggregate particles by (a) adding a chelating agent to a dispersion liquid of the aggregate particles, and then adding a monovalent water-soluble metal salt thereto, and (b) heating at a temperature of not less than a glass transition temperature of the resin having an acidic polar group.

First, an aggregation process and fusion process, which are characteristic processes in the present invention, will be described.

<Aggregation Process>

An aggregating agent is added to and mixed with the mixed dispersion liquid obtained in the mixing process, and when necessary heat and/or mechanical power is properly added to the mixed dispersion liquid. Thereby, an aggregate particle of the resin fine particle and the colorant fine particle is formed. The mixing process will be described later.

As the aggregating agent, an aggregating agent containing a divalent or higher-valent metal ion needs to be used. An aggregating agent containing a monovalent metal ion has a weak aggregation force, and a large amount thereof needs to be added in order to aggregate the resin fine particle. For this reason, the aggregate particle to be obtained is likely to have broad particle size distribution. Moreover, if a large amount of the aggregating agent is added, the aggregating agent is likely to remain in the toner. Meanwhile, the aggregating agent containing a divalent or higher-valent metal ion has a strong aggregation force. By addition of a small amount of the aggregating agent, an acidic polar group in the resin fine particle and an ionic surfactant contained in the aqueous dispersion liquid of the resin fine particle, the aqueous dispersion liquid of the colorant fine particle, and an aqueous dispersion liquid of a release agent fine particle are ionically neutralized, and the resin fine particle and the colorant fine particle are aggregated using an effect of salting-out and ionic crosslinking.

Examples of the aggregating agent containing a divalent or higher-valent metal ion include divalent or higher-valent metal salts or polymers of metal salts. Specifically, examples thereof include, but not limited to, divalent inorganic metal salts such as calcium chloride, calcium nitrate, magnesium chloride, magnesium sulfate, and zinc chloride; trivalent metal salts such as iron(III) chloride, iron(III) sulfate, aluminum sulfate, and aluminum chloride; and inorganic metal salt polymers such as poly aluminum chloride, poly aluminum hydroxide, and calcium polysulfide. These may be used singly or in combinations of two or more thereof. In the present invention, using the difference between the properties of the monovalent metal salt and those of the divalent or higher-valent metal salt, (a) the divalent or higher-valent metal salt or divalent or higher-valent metal salt polymer having a strong aggregation force is used as the aggregating agent in the aggregation process, and (b) the monovalent metal salt having a weak aggregation force is added in the fusion process in order to control the ion concentration within the system and promote the fusion while the particle diameter and distribution are kept.

The aggregating agent may be used as a dry powder or an aqueous solution of the aggregating agent dissolved in an aqueous medium. Preferably, the aggregating agent is added as an aqueous solution for uniform aggregation. Preferably, the aggregating agent is added and mixed at a temperature of not more than the glass transition temperature of the resin contained in the mixed dispersion liquid. If the aggregating agent is mixed under this temperature condition, uniform aggregation progresses. The aggregating agent can be mixed with the mixed dispersion liquid using a known mixing apparatus such as a homogenizer and a mixer.

In the aggregation process, another known material contained in the toner particle such as a charge control agent may be added. As the dispersed particle diameter of the material added at this time, the volume average particle diameter is preferably not more than 1 μm, and more preferably 0.01 to 1 μm. The dispersed particle diameter can be measured using a doppler scattering particle size distribution analyzer or a laser diffraction/scattering particle size distribution analyzer (LA-920: made by HORIBA, Ltd.).

A method for producing an aqueous dispersion liquid of a material contained in the toner particle other than the binder resin, the coloring agent, and the release agent is not particularly limited, and examples thereof include known dispersing machines such as a rotary shear homogenizer, a ball mill using a medium, a sand mill, a DYNO-MILL, and the same apparatus used for producing the aqueous dispersion of the release agent fine particle. An optimal dispersing machine can be selected according to the material and used.

The average particle diameter of the aggregate particle formed in the aggregation process is not particularly limited. Usually, the average particle diameter is preferably controlled to be approximately the same as the average particle diameter of the toner to be finally obtained. The particle diameter of the aggregate particle can be easily controlled by properly adjusting the temperature, the concentration of the solid content, the concentration of the aggregating agent, and the stirring condition.

Moreover, a toner particle having a core-shell structure can be produced by an application process of applying a resin fine particle for forming a shell phase onto the surface of the aggregate particle by further adding the resin fine particle to the dispersion liquid of the aggregate particle obtained in the aggregation process, and a fusion process of heating and fusing the aggregate particle having the resin fine particle applied onto the surface. The resin fine particle for forming a shell phase, which is added here, may be a resin fine particle having the same structure as that of the resin contained in the aggregate particle, or may be a resin fine particle having a different structure.

The resin for a shell contained such a resin fine particle for forming a shell phase is not particularly limited, and a known resin used for the toner can be used. Specifically, vinyl polymers such as styrene-acrylic copolymers, polyester resins, epoxy resins, polycarbonate resins, and polyurethane resins can be used. Among these, polyester resins or styrene-acrylic copolymers are preferred, and polyester resins are more preferred from the viewpoint of compatibility with the coloring agent, fixability, and durability. In the case where the polyester resin has a rigid aromatic ring in the main chain, the polyester resin is more flexible than the vinyl polymer such as styrene-acrylic copolymers. Accordingly, such a polyester resin can give mechanical strength equal to that of the vinyl polymer even if the polyester resin has a lower molecular weight than the vinyl polymer. For this reason, the polyester resin is preferred as a resin suitable for fixability at a low temperature.

In the present invention, the resins for a shell may be used singly or in combinations of two or more thereof.

<Fusion Process>

In the fusion process, a chelating agent is added to the dispersion liquid containing the aggregate particle obtained in the aggregation process under the same stirring as that in the aggregation process. By addition of the chelating agent, the ionic crosslinking between an acidic polar group in the resin fine particle and the divalent or higher-valent metal ion is partially dissociated to coordinate the metal ion with the chelating agent. This action stabilizes the dispersion state of the aggregate particle. After the dispersion state of the aggregate particle in the dispersion liquid is stabilized, a monovalent water-soluble metal salt is added to the dispersion liquid. Thereby, the ion concentration within the system is enhanced, and charges held by the aggregate particle in the aqueous medium are electrostatically shielded. This enhances the interface tension of the aggregate particle. Such an action that the aggregate particle reduces the surface area thereof works by heating the dispersion liquid to a temperature of not less than the glass transition temperature of the resin. As a result, the resin fine particle and the coloring agent particle can be fused. Using this action, fusion and control of the shape can be performed at the same time. This process can eliminate the high temperature condition required in the fusion process in the related art, and the fusion process can be quickly completed at a low temperature.

(Chelating Agent)

The chelating agent is not particularly limited as long as the chelating agent is a known water-soluble chelating agent. Specifically, examples thereof include oxycarboxylic acids such as tartaric acid, citric acid, and gluconic acid and organic metal salts thereof such as sodium salts thereof; and iminodiacetic acid (IDA), nitrilotriacetic acid (NTA), and ethylenediaminetetraacetic acid (EDTA) and organic metal salts thereof such as sodium salts thereof. The chelating agent is coordinated with the metal ion in the aggregating agent existing in the dispersion liquid of the aggregate particle. Thereby, the environment within the dispersion liquid can be changed from an electrostatically unstable state where aggregation easily occurs to an electrostatically stable state where further aggregation is difficult to occur. Thereby, further aggregation of the aggregate particle in the dispersion liquid can be suppressed to stabilize the aggregate particle. The chelating agent is preferably an organic metal salt having a trivalent or higher-valent carboxylic acid because the effect can be obtained even by adding a small amount of the chelating agent, and a toner particle having a sharp particle size distribution can be obtained. The amount of the chelating agent to be mixed is preferably 1 to 30 parts by mass, and more preferably 2.5 to 15 parts by mass based on 100 parts by mass of the resin from the viewpoint of satisfying stabilization from the aggregation state and washing efficiency of the toner at the same time.

(Monovalent Water-Soluble Metal Salt)

As the monovalent water-soluble metal salt, a known metal salt produced by neutralization of an acid and a base can be used. The monovalent water-soluble metal salt is not particularly limited as long as the monovalent water-soluble metal salt is soluble in the disperse medium. Examples thereof include the followings.

Specifically, examples thereof include, but not limited to, monovalent inorganic metal salts such as sodium chloride, sodium sulfate, potassium chloride, and sodium carbonate. The monovalent metal salt plays a role in enhancing the ion concentration within the system for the aggregate particle electrostatically stabilized by addition of the chelating agent and electrostatically shielding charges that stabilize the aggregate particle. For this reason, acidic salts and neutral salts are preferably used rather than basic salts by which the resin is dissociated to be electrostatically stabilized. Further, neutral salts are most preferably used because a modified resin or coarse powder is difficult to produce, and the pH within the system is not influenced. These may be used singly or in combinations of two or more thereof.

The monovalent water-soluble metal salt may be added to the dispersion liquid of the aggregate particle as a dry powder, or may be added as an aqueous solution prepared by dissolving the monovalent water-soluble metal salt in an aqueous medium. In order to uniformly mix the monovalent water-soluble metal salt, however, the monovalent metal salt is preferably added as an aqueous solution prepared by dissolving the monovalent water-soluble metal salt in water.

The amount of the monovalent water-soluble metal salt to be added varies according to the kind, content, and acid value of the acidic polar group in the resin or the surfactant present within the system, the particle diameter of the resin fine particle, and the kind of the aggregating agent used in the aggregation process and the amount thereof to be added, and cannot be determined generally. Excessive addition of the monovalent water-soluble metal salt leads to an electrostatically unstable state within the system, and a desired particle diameter cannot be kept. More preferably, the metal salt is added such that the concentration thereof is not more than a critical aggregation concentration of the aggregate particle stabilized by the chelating agent.

The critical aggregation concentration here refers to an index indicating stability of a dispersed substance in a dispersion liquid, and designates the concentration at which aggregation occurs by adding a metal salt. The critical aggregation concentration greatly changes according to a latex itself and a dispersant. The critical aggregation concentration corresponds to the “coagulation value” described in “Polymer Chemistry,” Seizo Okamura et al., 17,601 (1960), and can be determined by its description.

The heating temperature in the fusion process needs to be not less than glass transition temperature (Tg) of the resin contained in the aggregate particle. From the viewpoint of the energy reduction, the heating temperature is preferably not less than Tg and not more than (Tg+30° C.). The heating time is shorter at a higher heating temperature, and needs to be longer at a lower heating temperature. Namely, although the fusion time depends on the heating temperature and cannot be determined generally, usually, the fusion time is preferably 30 minutes to 10 hours. The aggregate particle is heated to have a predetermined average circularity. At this point of time, the aggregate particle is cooled to room temperature on a proper condition. The average circularity of the toner particle was measured using a flow type particle image measurement apparatus “FPIA-3000” (made by Sysmex Corporation) according to the operation manual of the apparatus, and calculated.

Hereinafter, processes other than the aggregation process and the fusion process will be specifically described.

<Mixing Process>

Specifically, the mixing process is a process of mixing the aqueous dispersion liquid of the resin particle prepared by dispersing the resin fine particle in an aqueous medium with the aqueous dispersion liquid of the colorant fine particle prepared by dispersing the colorant fine particle in an aqueous medium to obtain a mixed dispersion liquid having the resin fine particle and colorant fine particle for forming the toner particle. The order of mixing these is not particularly limited. These may be added at the same time and mixed, or one component after another may be added and mixed. From the viewpoint of uniformity of the mixed dispersion liquid, more preferably, mixing is performed while mechanical stirring is performed or a shear force is applied properly.

As the aqueous medium, water such as distilled water and ion exchange water are preferred. A hydrophilic solvent easily miscible with water such as methanol and acetone can be added in the range in which the stability of the dispersion liquid is not affected. From the viewpoint of an environmental load, the aqueous medium is preferably 100% by mass of water.

The resin contained in the resin fine particle serves as a binder resin when the toner is produced. Accordingly, a resin having an acidic polar group can be selected from known resins used as a binder resin for the toner, and used. Specifically, examples thereof include vinyl polymers such as styrene-acrylic copolymers, polyester resins, epoxy resins, polycarbonate resins, and polyurethane resins. Among these, polyester resins or styrene-acrylic copolymers are preferred, and polyester resins are more preferred from the viewpoint of compatibility with the coloring agent, fixability, and durability. In the case where the polyester resin has a rigid aromatic ring in the main chain, the polyester resin is more flexible than the vinyl polymer such as styrene-acrylic copolymers. Accordingly, such a polyester resin can give mechanical strength equal to that of the vinyl polymer even if the polyester resin has a lower molecular weight than the vinyl polymer. For this reason, the polyester resin is preferred as a resin suitable for fixability at a low temperature. Moreover, if the polyester resin and the polyurethane resin are exposed on a high temperature condition in the aqueous medium, the resins are likely to be modified, for example, hydrolyzed, according to the resin structure. In the fusion process according to the present invention, however, such modification of the resin can be suppressed by reducing the temperature. Accordingly, the polyester resin and the polyurethane resin are particularly suitably used.

In the present invention, the resins may be used singly or in combinations of two or more thereof. In the case where the resin contains the polyester resin, the polyester resin may be crystalline or non-crystalline. From the viewpoint of fluidity, suppression in offset, and durability, non-crystalline polyester resins are more preferred. The crystallinity and non-crystallinity can be determined by differential scanning calorimetry (DSC) of the polyester based on whether the polyester has the glass transition temperature and the melting point.

The monomer used as the raw material for the polyester resin is not particularly limited, and a known monomer can be used. Specifically, examples thereof include aliphatic, alicyclic, or aromatic polyvalent carboxylic acids and alkyl esters thereof; polyhydric alcohols and ester compounds thereof; and hydroxycarboxylic acid compounds. These can be directly subjected to an esterification reaction or polymerized using a transesterification reaction to obtain a polyester resin. The monomers that form crystalline polyester resins and the monomers that form the non-crystalline polyester resins both can be used. For the reason above, the monomers that form the non-crystalline polyester resins are preferred.

The polyhydric alcohol means a compound having two or more hydroxyl groups in one molecule, and is not particularly limited. Examples thereof can include monomers below. Examples of diols specifically include aliphatic diols such as 1,2-propanediol, 1,3-propanediol, 1,4-butanediol, 1,5-pentanediol, 1,6-hexanediol, 1,7-heptanediol, 1,8-octanediol, neopentyl glycol, and 1,4-butenediol; and diols having a cyclic structure such as cyclohexanediol, cyclohexanedimethanol, bisphenol A, bisphenol C, bisphenol E, bisphenol F, bisphenol P, bisphenol S, bisphenol Z, hydrogenated bisphenol, biphenol, naphthalenediol, 1,3-adamantanediol, 1,3-adamantanedimethanol, 1,3-adamantanediethanol, and hydroxyphenylcyclohexane. Preferably, the bisphenols have at least one alkylene oxide group. Examples of the alkylene oxide group can include, but not limited to, an ethylene oxide group, a propylene oxide group, and a butylene oxide group. Among these, the ethylene oxide group and the propylene oxide group are preferred. Preferably, the mol of the alkylene oxide group to be added is 1 to 3 moles. If the mol of the alkylene oxide group to be added is within this range, the viscoelasticity and glass transition temperature of the polyester resin to be produced can be properly controlled so as to be suitable for the purpose of using the polyester resin as the toner.

Examples of the trivalent or higher-valent alcohols specifically can include glycol, pentaerythritol, hexamethylolmelamine, hexaethylolmelamine, tetramethylolbenzoguanamine, and tetraethylolbenzoguanamine.

Among the polyhydric alcohols, aliphatic diols such as hexanediol, cyclohexanediol, octanediol, decanediol, and dodecanediol; and alkylene oxide adducts of bisphenol A, bisphenol C, bisphenol E, bisphenol S, and bisphenol Z are suitably used.

Polyvalent carboxylic acid is a compound having two or more carboxyl groups in one molecule, and not particularly limited. Examples thereof can include monomers below.

Specifically, examples thereof include aliphatic dicarboxylic acids such as oxalic acid, malonic acid, maleic acid, fumaric acid, citraconic acid, itaconic acid, glutaconic acid, succinic acid, adipic acid, sebacic acid, azelaic acid, n-dodecylsuccinic acid, n-dodecenylsuccinic acid, nonanedicarboxylic acid, decanedicarboxylic acid, undecanedicarboxylic acid, and dodecanedicarboxylic acid; alicyclic dicarboxylic acids such as 1,1-cyclopentenedicarboxylic acid, 1,4-cyclohexanedicarboxylic acid, 1,3-cyclohexanedicarboxylic acid, and 1,3-adamantanedicarboxylic acid; aromatic dicarboxylic acids such as phthalic acid, isophthalic acid, terephthalic acid, p-phenylenediacetic acid, m-phenylenediacetic acid, p-phenylenedipropionic acid, m-phenylenedipropionic acid, naphthalene-1,4-dicarboxylic acid, naphthalene-1,5-dicarboxylic acid, and naphthalene-2,6-dicarboxylic acid; and trivalent or higher-valent polyvalent carboxylic acids such as trimellitic acid, pyromellitic acid, naphthalene tricarboxylic acid, naphthalene tetracarboxylic acid, pyrenetricarboxylic acid, and pyrenetetracarboxylic acid. The carboxylic acids may have a functional group other than the carboxyl group. Carboxylic acid derivatives such as acid anhydrides and acid esters can also be used.

Among the polyvalent carboxylic acids, sebacic acid, nonanedicarboxylic acid, decanedicarboxylic acid, undecanedicarboxylic acid, dodecanedicarboxylic acid, p-phenylenediacetic acid, m-phenylenediacetic acid, p-phenylenedipropionic acid, m-phenylenedipropionic acid, 1,4-cyclohexanedicarboxylic acid, 1,3-cyclohexanedicarboxylic acid, naphthalene-1,4-dicarboxylic acid, naphthalene-1,5-dicarboxylic acid, naphthalene-2,6-dicarboxylic acid, trimellitic acid, and pyromellitic acid are suitably used.

Alternatively, using a hydroxycarboxylic acid compound having a carboxylic acid and a hydroxyl group in one molecule, the polyester resin can be obtained. Examples of such a monomer can include, but not limited to, hydroxyoctanoic acid, hydroxynonanoic acid, hydroxydecanoic acid, hydroxyundecanoic acid, hydroxydodecanoic acid, hydroxytetradecanoic acid, hydroxytridecanoic acid, hydroxyhexadecanoic acid, hydroxypentadecanoic acid, and hydroxystearic acid.

In the case where the vinyl polymer is used, the vinyl monomer that forms the vinyl polymer is not particularly limited, and examples thereof include vinyl monomers as mentioned below. The vinyl monomer means a compound having one vinyl group in one molecule.

Specifically, examples of the vinyl monomer include styrenes such as styrene and p-chlorostyrene; ethylene unsaturated monoolefins such as ethylene, propylene, butylene, and isobutylene; vinylesters such as vinyl acetate, vinyl propionate, vinyl benzoate, vinyl butyrate, vinyl formate, vinyl stearate, and vinyl caproate; acrylic (methacrylic) acids and esters thereof such as methyl acrylate, ethyl acrylate, n-butyl acrylate, isobutyl acrylate, dodecyl acrylate, n-octyl acrylate, 2-chloroethyl acrylate, phenyl acrylate, methyl-α-chloroacrylate, methyl methacrylate, ethyl methacrylate, and methacrylic acid; ethylenic monocarboxylic acid substitutes such as butylacrylonitrile, methacrylonitrile, and acrylamide; ethylenic dicarboxylic acids and esters thereof such as dimethyl maleate, diethyl maleate, and dibutyl maleate; vinyl ketones such as vinyl methyl ketone, vinyl hexyl ketone, and methyl isopropenyl ketone; vinyl ethers such as vinyl methyl ether, vinyl isobutyl ether, and vinyl ethyl ether; vinylidene halides such as vinylidene chloride and vinylidene chlorofluoride; and N-vinyl heterocyclic compounds such as N-vinylpyrrole, N-vinylcarbazole, N-vinylindole, and N-vinylpyrrolidone.

The vinyl polymer is a homopolymer of these vinyl monomer or a copolymer of two or more of these vinyl monomers, and can be polymerized by a known process such as a solution polymerization process, a bulk polymerization process, and a suspension polymerization process.

The polyurethane resin is a reaction product of a diol component and a diisocyanate component as a prepolymer. A resin having a variety of functionalities can be obtained by controlling the diol component and the diisocyanate component.

Examples of the diisocyanate component include: aromatic diisocyanates having 6 to 20 carbon atoms (excluding carbons in an NCO group, the same is true below), aliphatic diisocyanates having 2 to 18 carbon atoms, alicyclic diisocyanates having 4 to 15 carbon atoms, aromatic hydrocarbon diisocyanates having 8 to 15 carbon atoms, and modified products thereof (modified products containing an urethane group, a carbodiimide group, an allophanate group, an urea group, a biuret group, an uretdione group, an uretimine group, an isocyanurate group, and an oxazolidone group. Hereinafter, these are also referred to as modified diisocyanates), and a mixture of two or more thereof.

Examples of the aromatic diisocyanate include, but not particularly limited to, the following: 1,3-phenylene diisocyanate, 1,4-phenylene diisocyanate, and 1,5-naphthylene diisocyanate.

Examples of the aliphatic diisocyanate include: ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl)fumarate, bis(2-isocyanatoethyl)carbonate, and 2-isocyanatoethyl-2,6-diisocyanatohexanoate.

Examples of the alicyclic diisocyanate include: isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5-norbornane diisocyanate, and 2,6-norbornane diisocyanate.

Among these, aromatic diisocyanates having 6 to carton atoms, aliphatic diisocyanates having 4 to 12 carbon atoms, and alicyclic diisocyanates having 4 to 15 carbon atoms are preferred, and HDI and IPDI are particularly preferred.

As the polyurethane resin, in addition to the diisocyanate components described above, trifunctional or higher-functional isocyanate compounds can be used. Examples of the trifunctional or higher-functional isocyanate compounds include polyallyl polyisocyanate (PAPI), 4,4′,4″-triphenylmethane triisocyanate, m-isocyanatophenylsulfonyl isocyanate, and p-isocyanatophenylsulfonyl isocyanate.

Examples of the diol component usable for the polyurethane resin include alkylene glycols (such as ethylene glycol, 1,2-propylene glycol, 1,3-propylene glycol, 1,4-butanediol, 1,6-hexanediol, octanediol, decanediol, dodecanediol, tetradecanediol, neopentyl glycol, and 2,2-diethyl-1,3-propanediol); alkylene ether glycols (such as diethylene glycol, triethylene glycol, dipropylene glycol, polyethylene glycol, polypropylene glycol, and polytetramethylene ether glycol); alicyclic diols (such as 1,4-cyclohexanedimethanol and hydrogenated bisphenol A); bisphenols (such as bisphenol A, bisphenol F, and bisphenol S); alkylene oxide (such as ethylene oxide, propylene oxide, and butylene oxide) adducts of the alicyclic diols; alkylene oxide (such as ethylene oxide, propylene oxide, and butylene oxide) adducts of the bisphenols; and polylactonediol (poly-ε-caprolactonediol), and polybutadienediol.

In the present invention, from the viewpoint of high dispersion stability of the resin fine particle in the aqueous medium and dispersibility of the coloring agent in the toner particle, the resin contained in the resin fine particle needs to have an acidic polar group. Examples of such an acidic polar group include a carboxyl group, a sulfonic acid group, a phosphonic acid group, and a sulfinic acid group. Among these, from the viewpoint of the dispersion stability of the resin fine particle in the aqueous medium, the carboxyl group or the sulfonic acid group is more preferred. In order to provide high dispersion stability of the resin fine particle and obtain a toner of a small particle diameter in a sharp particle size distribution, the acid value of the resin is preferably 5 to 50 mgKOH/g, and more preferably 7 to 25 mgKOH/g.

The resin used in the present invention has a glass transition temperature (Tg) of preferably not less than 30° C. and not more than 70° C., and more preferably not less than 40° C. and not more than 60° C. At a glass transition temperature within this range, blocking resistance and fixability at a low temperature can be satisfied at the same time.

The glass transition temperature (Tg) of a resin is a value obtained by measuring according to the method (DSC method) described in ASTM D3418-82 at a heating rate of 3° C./min.

The aqueous dispersion liquid of the resin fine particle can be prepared by known processes described below (such as an emulsion polymerization process, a self-emulsion process, a phase inversion emulsion process in which a resin is emulsified by adding an aqueous medium to a resin solution dissolved in an organic solvent, and a forced emulsion process in which without using an organic solvent, a resin is forcibly emulsified by treating the resin at a high temperature in an aqueous medium), but the method is not limited to these.

In the case of the phase inversion emulsion process, first, a resin is dissolved in a solvent of a single amphiphilic organic solvent or a mixed solvent of amphiphilic organic solvents. While the resin solution is stirred by a known mixer such as a stirrer, an emulsifying machine, and a dispersing machine, a basic substance is dropped. Then, while the resin solution is further stirred, an aqueous medium is dropped. Thereby, at a certain point of time, an oil phase and an aqueous phase are inverted, and the oil phase becomes oil droplets. Then, a solvent removing process under reduced pressure is performed to obtain an aqueous dispersion liquid in which the resin is dispersed.

Here, the amphiphilic organic solvent means an organic solvent in which preferably not less than 5 g/L and more preferably not less than 10 g/L of the organic solvent is soluble in water at 20° C. Not less than 5 g/L of the amphiphilic organic solvent soluble in water at 20° C. can provide a smaller particle diameter, or can further improve the storage stability of the aqueous dispersion liquid to be obtained.

Examples of the amphiphilic organic solvent include alcohols such as ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol; ketones such as methyl ethyl ketone, methyl isobutyl ketone, ethyl butyl ketone, cyclohexanone, and isophorone; ethers such as tetrahydrofuran and dioxane; esters such as ethyl acetate, n-propyl acetate, isopropyl acetate, n-butyl acetate, isobutyl acetate, sec-butyl acetate, 3-methoxybutyl acetate, methyl propionate, ethyl propionate, diethyl carbonate, and dimethyl carbonate; glycol derivatives such as ethylene glycol, ethylene glycol monomethyl ether, ethylene glycol monoethyl ether, ethylene glycol monopropyl ether, ethylene glycol monobutyl ether, ethylene glycol ethyl ether acetate, diethylene glycol, diethylene glycol monomethyl ether, diethylene glycol monoethyl ether, diethylene glycol monopropyl ether, diethylene glycol monobutyl ether, diethylene glycol ethyl ether acetate, propylene glycol, propylene glycol monomethyl ether, propylene glycol monopropyl ether, propylene glycol monobutyl ether, propylene glycol methyl ether acetate, and dipropylene glycol monobutyl ether; and 3-methoxy-3-methylbutanol, 3-methoxybutanol, acetonitrile, dimethylformamide, dimethylacetamide, diacetone alcohol, and acetoethyl acetate. These solvents can be used singly or in mixed combinations of two or more thereof.

The basic substance may be inorganic and organic basic compounds. Specifically, examples thereof include inorganic bases such as ammonia, sodium hydroxide, potassium hydroxide, sodium carbonate, potassium carbonate, sodium hydrogen carbonate, and potassium hydrogen carbonate; and organic bases such as methylamine, dimethylamine, trimethylamine, ethylamine, diethylamine, triethylamine, dimethylaminoethanol, diethylaminoethanol, sodium succinate, and sodium stearate. Among these, amines such as dimethylamine, triethylamine, and dimethylaminoethanol that are weak bases are preferred from the viewpoint of preventing hydrolysis.

The amount of the basic substance to be added is preferably properly adjusted such that the pH during dispersion and mixing is neutral or in the vicinity thereof (pH=6 to 8). The basic substance tends to reduce the particle diameter of the obtained resin fine particle as the amount thereof to be added is increased. In the case where a strong base is used as the basic substance and the resin is the polyester resin or the polyurethane resin, the amount of the basic substance to be added needs to be limited so as to prevent hydrolysis of the resin. From such a viewpoint, the amount of the basic substance to be added is preferably 0.20 to 2.50 equivalents, more preferably 0.35 to 2.00 equivalents, and still more preferably 0.50 to 1.75 equivalents, based on the acidic polar group in the resin.

The basic substances may be used singly or in combinations of two or more thereof. The basic substance may be used as it is, or in order to uniformly add the basic substance, the basic substance may be added to an aqueous medium in advance to prepare a solution, and the solution may be mixed.

In the case where the resin is the vinyl polymer, the vinyl monomer is polymerized suitably using a known polymerization process such as emulsion polymerization, miniemulsion polymerization, and seed polymerization. The resin is dispersed in an aqueous medium to prepare an aqueous dispersion liquid of the resin fine particle.

Generally, the particle diameter of the toner is approximately 3 to 8 μm. Accordingly, as the dispersed particle diameter of the resin fine particle in the aqueous dispersion liquid, in order to keep uniformity of the composition of the toner particle produced by the aggregation process and the fusion process, the 50% particle diameter (d50) based on volume distribution is preferably not more than 0.5 μm. For the same reason, the 90% particle diameter (d90) based on volume distribution is preferably not more than 1 μm. The dispersed particle diameter of the resin fine particle dispersed in the aqueous medium can be measured by a doppler scattering particle size distribution analyzer or a laser diffraction/scattering particle size distribution analyzer (LA-920: made by HORIBA, Ltd.).

Examples of known mixer used for dispersing the resin such as a stirrer, an emulsifying machine, and a dispersing machine include an ultrasonic homogenizer, a jet mill, a pressure homogenizer, a colloid mill, a ball mill, and a sand mill. These may be used singly or in combinations of two or more thereof.

The coloring agent is not particularly limited, and can be properly selected from known dyes and pigments according to the purpose. In the case where a dye is used, oil-soluble dyes, direct dyes, acidic dyes, basic dyes, reactive dyes, water-soluble dyes for food colors, or disperse dyes can be used. In the case where a pigment is used, organic pigments and inorganic pigments may be used. The coloring agents may be used singly or in mixed combinations of two or more thereof. The pigment and the dye may be used in combination. In the case where the coloring agents are used in combinations of two or more thereof, the coloring agents of the same color may be used in combination, or the coloring agents of different colors may be used in combination. In the case where the pigment and the dye are used in combination, the content of the dye is preferably not more than 100 parts by mass based on 100 parts by mass of the pigment from the viewpoint of lightfastness.

As the cyan coloring agent, copper phthalocyanine compounds and derivatives thereof, anthraquinone compounds, and basic dye lake compounds are used. Specifically, examples thereof include C.I. Pigment Blue 1, C.I. Pigment Blue 7, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 60, C.I. Pigment Blue 62, and C.I. Pigment Blue 66.

As the magenta coloring agent, condensation azo compounds, diketopyrrolopyrrole compounds, anthraquinone, quinacridone compounds, basic dye lake compounds, naphthol compounds, benzimidazolone compounds, thioindigo compounds, and perylene compounds are used. Specifically, examples thereof include C.I. Pigment Red 2, C.I. Pigment Red 3, C.I. Pigment Red 5, C.I. Pigment Red 6, C.I. Pigment Red 7, C.I. Pigment Violet 19, C.I. Pigment Red 23, C.I. Pigment Red 48:2, C.I. Pigment Red 48:3, C.I. Pigment Red 48:4, C.I. Pigment Red 57:1, C.I. Pigment Red 81:1, C.I. Pigment Red 122, C.I. Pigment Red 144, C.I. Pigment Red 146, C.I. Pigment Red 166, C.I. Pigment Red 169, C.I. Pigment Red 177, C.I. Pigment Red 184, C.I. Pigment Red 185, C.I. Pigment Red 202, C.I. Pigment Red 206, C.I. Pigment Red 220, C.I. Pigment Red 221, and C.I. Pigment Red 254.

As the yellow coloring agent, condensation azo compounds, isoindolinone compounds, anthraquinone compounds, azo metal complexes, methine compounds, and allylamide compounds are used. Specifically, examples thereof include C.I. Pigment Yellow 12, C.I. Pigment Yellow 13, C.I. Pigment Yellow 14, C.I. Pigment Yellow 15, C.I. Pigment Yellow 17, C.I. Pigment Yellow 62, C.I. Pigment Yellow 74, C.I. Pigment Yellow 83, C.I. Pigment Yellow 93, C.I. Pigment Yellow 94, C.I. Pigment Yellow 95, C.I. Pigment Yellow 97, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 147, C.I. Pigment Yellow 151, C.I. Pigment Yellow 154, C.I. Pigment Yellow 155, C.I. Pigment Yellow 168, C.I. Pigment Yellow 174, C.I. Pigment Yellow 175, C.I. Pigment Yellow 176, C.I. Pigment Yellow 180, C.I. Pigment Yellow 181, C.I. Pigment Yellow 191, and C.I. Pigment Yellow 194.

As the black coloring agent, carbon black, magnetic materials, or the yellow coloring agents/magenta coloring agents/cyan coloring agents shown above and used in combinations of two or more thereof to have a color of black by toning can be used. The coloring agent may be a pigment surface treated by a known method.

The amount of the coloring agent to be contained is preferably 1 to 30 parts by mass based on 100 parts by mass of the binder resin contained in the toner particle.

The aqueous dispersion of the colorant fine particle can be prepared by known methods shown below, but the methods are not limited to these.

The aqueous dispersion of the colorant fine particle can be prepared by mixing the coloring agent, the aqueous medium, and a dispersant using a known mixer such as a stirrer, an emulsifying machine, and a dispersing machine. The dispersant used here may be a known dispersant such as a surfactant and a polymer dispersant, or may be a novel dispersant synthesized for the present invention. Both of the surfactant and the polymer dispersant can be removed in a toner washing process described later. From the viewpoint of washing efficiency, the surfactants are preferred. Among these, anionic surfactants and non-ionic surfactants are more preferred. The amount of the dispersant to be mixed is preferably 1 to 20 parts by mass, and more preferably 2 to 10 parts by mass based on 100 parts by mass of the coloring agent from the viewpoint of satisfying dispersion stability and toner washing efficiency at the same time. The content of the coloring agent in the aqueous dispersion liquid of the colorant fine particle is not particularly limited. The content of the coloring agent is preferably 1 to 30% by mass based on the total mass of the aqueous dispersion liquid. As the dispersed particle diameter of the colorant fine particle in the aqueous dispersion liquid, the 50% particle diameter (d50) based on volume distribution is preferably not more than 0.5 μm from the viewpoint of dispersibility of the pigment in the toner to be finally obtained. For the same reason, the 90% particle diameter (d90) based on volume distribution is preferably not more than 2 μm. The dispersed particle diameter of the colorant fine particle dispersed in the aqueous medium can be measured by a laser diffraction/scattering particle size distribution analyzer (LA-920: made by HORIBA, Ltd.).

Examples of a known mixer such as a stirrer, an emulsifying machine, and a dispersing machine used for dispersing the coloring agent in the aqueous medium include an ultrasonic homogenizer, a jet mill, a pressure homogenizer, a colloid mill, a ball mill, a sand mill, and a paint shaker. These may be used singly or in combinations of two or more thereof.

Examples of the surfactant include anionic surfactants such as sulfuric acid ester salt surfactants, sulfonic acid salt surfactants, phosphoric acid ester surfactants, and soaps; cationic surfactants such as amine salt surfactants and quaternary ammonium salt surfactants; and nonionic surfactants such as polyethylene glycol surfactants, alkylphenol ethylene oxide adduct surfactants, and polyhydric alcohol surfactants. Among these, nonionic surfactants or anionic surfactants are preferred. The nonionic surfactants and the anionic surfactants may be used in combination. The surfactants may be used singly or in combinations of two or more thereof. The concentration of the surfactant in the aqueous medium is preferably 0.5 to 5% by mass.

The toner particle may contain a release agent. The melting point of the release agent is preferably not more than 150° C., more preferably not less than 40° C. and not more than 130° C., and particularly preferably not less than 40° C. and not more than 110° C.

Examples of the release agent specifically include, but not limited to, low molecular weight polyolefins such as polyethylene; silicones having a melting point (softening point) by heating; fatty acid amides such as oleamide, erucamide, ricinoleamide, and stearamide; ester waxes such as stearyl stearate; plant waxes such as carnauba wax, rice wax, candelilla wax, Japan wax, and jojoba oil; animal waxes such as bee wax; mineral and petroleum waxes such as montan wax, ozokerite, ceresin, paraffin wax, microcrystalline wax, Fischer-Tropsch wax, ester wax; and modified products thereof. These release agents may be used singly or in mixed combinations of two or more thereof.

The aqueous dispersion of the release agent fine particle can be prepared by known methods shown below, but the methods are not limited to these.

The aqueous dispersion of the release agent fine particle can be prepared as follows: the release agent is added to an aqueous medium containing a surfactant, and heated to the temperature of not less than melting point of the release agent; the release agent is dispersed in a state of particles using a homogenizer having an ability to give a strong shear force (e.g., “Cleamix W-Motion” made by M Technique Co., Ltd.) or a pressure eject dispersing machine (e.g., “Gaulin Homogenizer” made by APV Gaulin Company), and cooled to the melting point or less.

As the dispersed particle diameter of the release agent fine particle in the aqueous dispersion liquid, the 50% particle diameter (d50) based on volume distribution is preferably 80 to 500 nm, and more preferably 100 to 300 nm. Preferably, no coarse particles having a particle diameter of not less than 600 nm are present. If the dispersed particle diameter of the release agent fine particle is within this range, the release agent can be eluted well during fixing to increase a hot offset temperature and suppress filming to a photoreceptor. The dispersed particle diameter can be measured by a laser diffraction/scattering particle size distribution analyzer (LA-920: made by HORIBA, Ltd.).

In the aqueous dispersion of the release agent fine particle, the proportion of the surfactant to the release agent is preferably not less than 1% by mass and not more than 20% by mass. At a proportion of the surfactant within this range, the storage stability of the toner and charging properties of the toner, particularly environmental stability can be improved.

The amount of the release agent to be used is preferably 1 to 30 parts by mass based on 100 parts by mass of the binder resin contained in the toner particle.

The concentration of the solid content in the mixed dispersion liquid obtained in the mixing process can be properly adjusted when necessary by adding water. In the aggregation process, in order to provide uniform aggregation, the concentration of the solid content is preferably 5 to 40% by mass, more preferably 5 to 30% by mass, and particularly preferably 5 to 20% by mass.

<Washing Process>

The wet toner particle obtained at the end of the fusion process is washed, filtered, and dried to obtain a toner particle.

In washing, pure water having a conductivity of not less than 0 μS/cm and not more than 30 μS/cm is preferably used. Preferably, the wet toner particle is washed until the conductivity of the supernatant solution of water used to wash the wet toner particle reaches not less than 0 μS/cm and not more than 100 μS/cm. More preferably, the wet toner particle is washed until the conductivity of the supernatant solution of water used to wash the wet toner particle reaches not less than 0 μS/cm and not more than 50 μS/cm. Alternatively, the washing process may include not only washing with pure water, but also at least one process of washing with water whose pH is properly adjusted according to the kind of impurities to be removed. Such washing of the wet toner particle is performed in order to remove impurities that influence particularly charging properties and environmental stability of the toner, such as the surfactant, the aggregating agent, and the metal salt. By this washing process, a toner having a small amount of impurities can be easily produced.

<External Addition Process>

An inorganic particle of silica, alumina, titania, or calcium carbonate or an organic particle of a vinyl resin, a polyester resin, a silicone resin, or a fluorine resin may be applied or fixed onto the surface of the toner particle obtained by washing, filtration, and drying as above.

These inorganic particles and organic particles function as an external additive such as a fluidity improver, a cleaning aid, and a polishing agent. Further, a lubricant may be added to the toner particle. Examples of the lubricant include fatty acid amides such as ethylenebisstearamide and oleamide; fatty acid metal salts such as zinc stearate and calcium stearate; and higher alcohols such as UNILIN (registered trademark; made by Toyo-Petrolite Co., Ltd.). These are generally added in order to improve cleaning properties. The average particle diameter of the primary particle is preferably 0.1 to 5.0 μm.

<Measurement of Acid Value of Resin>

The acid value of the resin such as the binder resin is determined as follows. The basic operation is according to JIS-K0070. The acid value means the mass of potassium hydroxide in “mg” required to neutralize an acid contained in 1 g of a sample.

(1) Reagent

(a) Preparation of Solvent:

An ethyl ether-ethyl alcohol mixed solution (volume ratio of 1:1 or 2:1) or a benzene-ethyl alcohol mixed solution (volume ratio of 1:1 or 2:1) is used. Immediately before use, these solutions are neutralized with a 0.1 mol/L potassium hydroxide ethyl alcohol solution using phenolphthalein as an indicator.

(b) Preparation of Phenolphthalein Solution:

A solution prepared by dissolving 1 g of phenolphthalein in 100 ml of ethyl alcohol (95% by volume) is used.

(c) Preparation of 0.1 mol/L Potassium Hydroxide-Ethyl Alcohol Solution:

7.0 g of potassium hydroxide is dissolve in a minimal amount of water, and ethyl alcohol (95% by volume) is added such that the total volume is 1 L. The solution is left as it is for 2 to 3 days, and filtered. Determination is performed according to JIS K 8006 (basic matters concerning titration in a test of the content of a reagent).

(2) Operation

1 to 20 g of a sample resin is precisely weighed, and placed in a conical flask. 100 ml of the solvent and several drops of the phenolphthalein solution as the indicator are added into the conical flask, and the flask is sufficiently shaken until the sample is completely dissolved. In the case of a solid sample, the sample is heated on a water bath and dissolved. After cooling, the obtained solution is titrated with the 0.1 mol/L potassium hydroxide ethyl alcohol solution. When a light red color of the indicator continues for 30 seconds, this is defined as the end point of neutralization.

(3) Calculation Expression

An acid value A is calculated using the expression:

A=B×f×5.611/S

(B: amount of the 0.1 mol/L potassium hydroxide ethyl alcohol solution to be used (ml)

f: factor of the 0.1 mol/L potassium hydroxide ethyl alcohol solution

S: sample (g))

<Measurement of Particle Size Distribution and Particle Diameter of Fine Particle Such as Resin Fine Particle>

The particle size distribution of the fine particle such as the resin fine particle (resin fine particle, colorant fine particle, release agent fine particle) in the aqueous dispersion liquid is measured using a laser diffraction/scattering particle size distribution analyzer (LA-920: made by HORIBA, Ltd.) according to the operation manual of the apparatus.

Specifically, a sample to be measured was adjusted such that the transmittance fell within the measurement range (70 to 95%) at a sample introduction portion of the analyzer, and the volume distribution of the fine particle based on the volume was measured. Then, the 50% particle diameter (d50) based on volume distribution and the proportion of the coarse particle having a particle diameter of not less than 0.8 μm were determined.

The 50% particle diameter (d50) based on volume distribution is a particle diameter corresponding to a 50% cumulative diameter (median size).

<Measurement of Number Average Particle Diameter (D1) and Weight-Average Particle Diameter of Toner Particle (D4)>

The number average particle diameter (D1) and weight-average particle diameter (D4) of the toner particle are measured by particle size distribution analysis according to a Coulter method. Using a Coulter Multisizer III (made by Beckman Coulter, Inc.) as a measurement apparatus, the measurement is performed according to the operation manual of the apparatus. Using first grade sodium chloride, an approximately 1% sodium chloride aqueous solution is prepared as the electrolyte solution. For example, an ISOTON-II (made by Beckman Coulter, Inc.) can be used. As a specific measurement method, 0.1 to 5 ml of a surfactant (alkylbenzenesulfonic acid salt) as a dispersant is added to 100 to 150 ml of the electrolytic aqueous solution, and 2 to 20 mg of a sample to be measured (toner particle) is further added. The sample in which the electrolyte solution is suspended is dispersed for approximately 1 to 3 minutes by an ultrasonic disperser. Using the obtained dispersed solution, the volume and number of the toner having a particle diameter of not less than 2.00 μm are measured by the measurement apparatus having an aperture tube of 100 μm as an aperture attached thereto. Then, the volume distribution and number distribution of the toner are calculated. Then, the number average particle diameter (D1) and weight-average particle diameter (D4) of the toner particle (a median in each channel is defined as a representative value of each channel) are determined.

As the channel, 13 channels of 2.00 to 2.52 μm; 2.52 to 3.17 μm; 3.17 to 4.00 m; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm are used.

<Measurement of Weight-Average Molecular Weight (Mw) and Number Average Molecular Weight (Mn) of Resin>

The weight-average molecular weight (Mw) and number average molecular weight (Mn) of the resin are measured by gel permeation chromatography (GPC) as follows.

First, a sample (resin) is dissolved in tetrahydrofuran (THF) at room temperature over 24 hours. The obtained sample solution is filtered with a solvent-resistant membrane filter “Maeshori Disk” having a pore diameter of 0.2 μm (made by Tosoh Corporation) to obtain a sample solution. The sample solution is adjusted such that the concentration of the component soluble in THF is approximately 0.8% by mass. The sample solution is measured on the following condition:

apparatus: HLC8120 GPC (detector: RI) (made by Tosoh Corporation)

column: seven columns of Shodex KF-801, 802, 803, 804, 805, 806, and 807 (made by Showa Denko K.K.)

eluent: tetrahydrofuran (THF)

flow rate: 1.0 ml/min

oven temperature: 40.0° C.

amount of the sample to be injected: 0.10 ml

In calculation of the molecular weight of the sample, a molecular weight calibration curve created using a standard polystyrene resin (such as trade names “TSK Standard Polystyrenes F-850, F-450, F-288, F-128, F-80, F-40, F-20, F-10, F-4, F-2, F-1, A-5000, A-2500, A-1000, and A-500,” made by Tosoh Corporation) is used.

<Measurement of Glass Transition Temperature (Tg) of Resin>

measurement apparatus: differential scanning calorimeter (DSC), MDSC-2920 (made by TA Instruments)

The glass transition temperature (Tg) of the resin is measured according to ASTM D3418-82. 2 to 10 mg, and preferably 3 mg of a sample to be measured is precisely weighed. The sample is placed in an aluminum pan. As a reference, using an empty aluminum pan, the measurement is performed under normal temperature and normal humidity in the measurement temperature range of 30 to 200° C. A prehistory is eliminated by conducting heating and cooling once. Then, analysis is performed using a DSC curve obtained when conducting heating at a heating rate of 10° C./min.

### EXAMPLES

Hereinafter, the present invention will be specifically described using Examples, but embodiments of the present invention will not be limited to these.

<Synthesis of Polyester Resin A: Low Softening Point Resin>

| | |
|---|---|
| polyoxypropylene (2,2)-2,2-bis(4-hydroxyphenyl)propane | 25 mol % |
| polyoxyethylene (2,0)-2,2-bis(4-hydroxyphenyl)propane | 25 mol % |
| terephthalic acid | 26 mol % |
| fumaric acid | 20 mol % |
| trimellitic acid | 4 mol % |

The materials above were placed in a two-necked flask sufficiently heated and dried. 0.05 parts by mass of dibutyltin oxide was added based on 100 parts by mass of the mixture of the material. While an inert atmosphere was kept by introducing nitrogen gas into a container, the temperature was raised, and a cocondensation polymerization reaction was performed at 230° C. for approximately 12 hours. Then, the pressure was reduced to 20 mmHg, and the temperature was raised to 250° C. Further, the cocondensation polymerization reaction was performed for 2 hours to synthesize Polyester Resin A having an acidic polar group.

The weight-average molecular weight (Mw) of Polyester Resin A obtained was 11000, and the number average molecular weight (Mn) was 5100.

Polyester Resin A had a glass transition temperature of 56° C. and an acid value of 12 mgKOH/g.

<Synthesis of Polyester Resin B: High Softening Point Resin>

| | |
|---|---|
| polyoxypropylene (2,2)-2,2-bis(4-hydroxyphenyl)propane | 25 mol % |
| polyoxyethylene (2,0)-2,2-bis(4-hydroxyphenyl)propane | 25 mol % |
| terephthalic acid | 26 mol % |
| fumaric acid | 14 mol % |
| trimellitic acid | 10 mol % |

The materials above were placed in a two-necked flask sufficiently heated and dried. 0.05 parts by mass of dibutyltin oxide was added based on 100 parts by mass of the mixture of the material. While an inert atmosphere was kept by introducing nitrogen gas into a container, the temperature was raised, and a cocondensation polymerization reaction was performed at 230° C. for approximately 12 hours. Then, the pressure was reduced to 20 mmHg, and the temperature was raised to 250° C. Further, the cocondensation polymerization reaction was performed for 6 hours to synthesize Polyester Resin B having an acidic polar group.

The weight-average molecular weight (Mw) of Polyester Resin B obtained was 32000, and the number average molecular weight (Mn) was 6000.

Polyester Resin B had a glass transition temperature of 59° C. and an acid value of 15 mgKOH/g.

<Preparation of Aqueous Dispersion Liquid of Resin Fine Particle Containing Polyester Resin A>

Polyester Resin A (1200 parts by mass) and an anionic surfactant (made by Dai-ichi Kogyo Seiyaku Co., Ltd.: NEOGENSC-A) (0.5 parts by mass) were dissolved in THF (2400 parts by mass). Dimethylaminoethanol (1 equivalent based on the acid value of Polyester Resin A) was added, and the solution was stirred for 10 minutes. Then, while the solution was stirred at a number of rotation of 5000 r/min using a homogenizer (made by IKA Works GmbH & Co. KG: ULTRA-TURRAXT50), ion exchange water (3600 parts by mass) was dropped. The obtained mixture was treated under reduced pressure (50 mmHg) at 50° C. to remove THF. Thus, an aqueous dispersion liquid of the resin fine particle containing Polyester Resin A (hereinafter, also referred to as an aqueous dispersion liquid of Polyester Resin A) was obtained (concentration of the solid content: 25% by mass, 50% particle diameter (d50) based on volume distribution: 120 nm).

<Preparation of Aqueous Dispersion Liquid of the Resin Fine Particle Containing Polyester Resin B>

Preparation was performed by the same preparation process as that in the case of the aqueous dispersion liquid of Polyester Resin A except that Polyester Resin A was replaced by Polyester Resin B. Thus, an aqueous dispersion liquid of the resin fine particle containing Polyester Resin B (hereinafter, also referred to as an aqueous dispersion liquid of Polyester Resin B) was obtained (concentration of the solid content: 25% by mass, 50% particle diameter (d50) based on volume distribution: 100 nm).

<Preparation of Aqueous Dispersion Liquid of Resin Fine Particle Containing Styrene-Acrylic Copolymer A>

| | |
|---|---|
| styrene | 350 parts by mass |
| n-butyl acrylate | 100 parts by mass |
| acrylic acid | 3 parts by mass |
| n-dodecylmercaptan | 10 parts by mass |

The materials above were mixed to prepare a monomer solution. The monomer solution and a surfactant aqueous solution prepared by dissolving 10 parts by mass of an anionic surfactant (made by Dai-ichi Kogyo Seiyaku Co., Ltd.: NEOGENRK) in 1130 parts by mass of ion exchange water were placed in a two-necked flask. Using a homogenizer (made by IKA Works GmbH & Co. KG: ULTRA-TURRAXT50), the solution was stirred at a number of rotation of 10000 r/min to emulsify the solution. Then, an atmosphere within the flask was replaced with nitrogen. While stirring was slowly performed, the content in a water bath was heated to 70° C. Then, 7 parts by mass of ion exchange water having 3 parts by mass of ammonium persulfate dissolved therein was added, and the polymerization was started. The reaction was continued for 8 hours, and the reaction solution was cooled to room temperature. Thus, Styrene-Acrylic Copolymer A containing the aqueous dispersion liquid of the resin fine particle having an acidic polar group (hereinafter, also referred to as an aqueous dispersion liquid of Styrene-Acrylic Copolymer A) was obtained. In Styrene-Acrylic Copolymer A, the 50% particle diameter based on volume distribution was 150 nm, the glass transition temperature (Tg) was 53° C., the weight-average molecular weight (Mw) was 30,000, Mw/Mn was 2.6, and the acid value was 1 mgKOH/g.

<Synthesis of Polyurethane Resin A>

100 parts by mass of Polyester Resin A and 10 parts by mass of 1,9-nonanediol were dissolved in 500 parts by mass of toluene. Then, 4 parts by mass of isophorone diisocyanate was added to toluene, and the reaction was conducted at 110° C. for 5 hours to obtain a mixture. Next, the obtained mixture was treated under reduced pressure (20 mmHg) at 50° C. to remove toluene. Thus, Polyurethane Resin A having an acidic polar group was obtained in which the glass transition temperature (Tg) was 55° C., the weight-average molecular weight (Mw) was 60,000, and the acid value was 8 mgKOH/g.

<Preparation of Aqueous Dispersion Liquid of Resin Fine Particle Containing Polyurethane Resin A>

Polyurethane Resin A (1200 parts by mass) and an anionic surfactant (made by Dai-ichi Kogyo Seiyaku Co., Ltd.: NEOGENSC-A) (0.5 parts by mass) were dissolved in THF (2400 parts by mass). Then, dimethylaminoethanol (1 equivalent based on the acid value of Polyurethane Resin A) was added, and the solution was stirred for 10 minutes. Then, while the solution was stirred at a number of rotation of 5000 r/min using a homogenizer (made by IKA Works GmbH & Co. KG: ULTRA-TURRAXT50), ion exchange water (3600 parts by mass) was dropped. The obtained mixture was treated under reduced pressure (50 mmHg) at 50° C. to remove THF. Thus, an aqueous dispersion liquid of the resin fine particle containing Polyurethane Resin A (hereinafter, also referred to as an aqueous dispersion liquid of Polyurethane Resin A) was obtained (concentration of the solid content: 25% by mass, 50% particle diameter (d50) based on volume distribution: 150 nm).

<Preparation of Aqueous Dispersion Liquid of Colorant Fine Particle Containing Coloring Agent>

| | |
|---|---|
| cyan pigment (C.I. Pigment Blue 15:3) | 100 parts by mass |
| anionic surfactant (made by Dai-ichi Kogyo Seiyaku | 10 parts by mass |
| Co., Ltd.: NEOGEN RK) | |
| ion exchange water | 890 parts by mass |

The materials above were mixed, and, using a homogenizer (made by IKA Works GmbH & Co. KG: ULTRA-TURRAXT50), were dispersed at a number of rotation of 24000 r/min for 30 minutes. Then, using a high pressure impact dispersing machine Nanomizer (made by YOSHIDA KIKAI CO., LTD.), the materials above were further dispersed under the condition of a pressure of 200 MPa. Thus, an aqueous dispersion liquid of a colorant fine particle containing a coloring agent in which a cyan pigment was dispersed (hereinafter, also referred to as an aqueous dispersion liquid of the colorant fine particle) was prepared. In the aqueous dispersion liquid of the colorant fine particle, the 50% particle diameter based on volume distribution of the coloring agent (cyan pigment) was 0.12 μm, and the concentration of the coloring agent was 10% by mass.

<Preparation of Aqueous Dispersion Liquid of Release Agent Fine Particle Containing Release Agent>

| | |
|---|---|
| ester wax (behenyl behenate, melting point of 75° C.) | 100 parts by mass |
| anionic surfactant (made by Dai-ichi Kogyo Seiyaku | 10 parts by mass |
| Co., Ltd.: NEOGENRK) | |
| ion exchange water | 880 parts by mass |

The materials above were placed in a mixing container with a jacket. While the materials were heated to 90° C. and circulated by a constant volume pump, the materials were stirred using a Cleamix W-Motion (M Technique Co., Ltd.) under the conditions of a number of rotation of the rotor of 19000 r/min and a number of rotation of the screen of 19000 r/min, and dispersed for 60 minutes. Subsequently to the dispersion for 60 minutes, the obtained dispersion was cooled to 40° C. under the conditions of a number of rotation of the rotor of 1000 r/min, a number of rotation of the screen of 0 r/min, and a cooling rate of 10° C./min. Thus, an aqueous dispersion liquid of the release agent fine particle containing release agent (hereinafter, also referred to as an aqueous dispersion liquid of the release agent fine particle) was obtained.

The aqueous dispersion liquid of the release agent fine particle was measured using a laser diffraction/scattering particle size distribution analyzer (LA-950: made by HORIBA, Ltd.). In the release agent fine particle, the 50% particle diameter based on volume distribution was 0.15 μm, and the proportion of a coarse particle having a particle diameter of not less than 0.8 μm was not more than 0.01%.

### Example 1

### Aggregation Process

| | |
|---|---|
| aqueous dispersion liquid of Polyester Resin A | 600 parts by mass |
| aqueous dispersion liquid of the colorant fine | 75 parts by mass |
| particle | |
| aqueous dispersion liquid of the release agent fine | 150 parts by mass |
| particle | |
| 1% by mass magnesium sulfate aqueous solution | 150 parts by mass |
| ion exchange water | 525 parts by mass |

The materials above were placed in a round stainless steel flask, and mixed. To this solution, an aqueous solution prepared by dissolving 1.5 parts of magnesium sulfate by mass based on 148.5 parts by mass of ion exchange water was added. Using a homogenizer (made by IKA Works GmbH & Co. KG: ULTRA-TURRAXT50), the materials were dispersed at 5000 r/min for 10 minutes. Then, the obtained mixed solution was heated to 48° C. while the number of rotation was properly adjusted such that the mixed solution was stirred in a heating oil bath using a stirring blade. The solution was kept at 48° C. for 1 hour. Then, the volume average particle diameter of the formed aggregate particle was measured using a flow type particle image analyzer (made by Sysmex Corporation: FPIA-3000) according to the operation manual of the apparatus. As a result, it was found that an aggregate particle whose volume average particle diameter was approximately 5.1 μm was formed.

<Fusion Process>

An aqueous solution prepared by dissolving 15 parts by mass of trisodium citrate in 285 parts by mass of ion exchange water was added to the dispersion liquid of the aggregate particle obtained in the aggregation process. Then, an aqueous solution prepared by dissolving 4.5 parts by mass of sodium chloride in 145.5 parts by mass of ion exchange water was added. While the solution was continuously stirred, the solution was heated to 75° C., and kept at 75° C. for 2 hours. The volume average particle diameter and average circularity of the obtained particle were measured using a flow type particle image analyzer (made by Sysmex Corporation: FPIA-3000) according to the operation manual of the apparatus. As a result, it was found that a sufficiently fused and integrated particle whose volume average particle diameter was approximately 5.4 μm and average circularity was 0.963 was formed. Then, the filtrate was sufficiently washed with ion exchange water, and dried using a vacuum dryer to obtain Toner Particle 1.

Toner Particle 1 was measured by the Coulter Multisizer III (made by Beckman Coulter, Inc.). The weight-average particle diameter (D4) was 5.4 μm, and the number average particle diameter (D1) was 4.7 μm. Namely, D4/D1 was 1.15, and Toner Particle 1 had a sharp particle size distribution. The circularity of Toner Particle 1 was measured using a flow type particle image analyzer (made by Sysmex Corporation: FPIA-3000). The average circularity was 0.965.

### Example 2

Toner Particle 2 was obtained in the same manner as in Example 1 except that the heating temperature in the fusion process was 95° C., and this temperature was kept for 0.5 hours. Toner Particle 2 had a weight-average particle diameter D4 of 5.5 μm, D4/D1 of 1.15, and an average circularity of 0.966.

### Example 3

Toner Particle 3 was obtained in the same manner as in Example 1 except that the aqueous dispersion liquid of Polyester Resin A was replaced by the aqueous dispersion liquid of Polyester Resin B, the amount of sodium chloride to be added in the fusion process was changed from 4.5 parts by mass to 12 parts by mass, and the solution was kept at 75° C. for 3 hours. Toner Particle 3 had a weight-average particle diameter D4 of 5.7 μm, D4/D1 of 1.15, and an average circularity of 0.959.

### Example 4

### Aggregation Process

| | |
|---|---|
| aqueous dispersion liquid of Polyester Resin A | 450 parts by mass |
| aqueous dispersion liquid of Polyester Resin B | 150 parts by mass |
| aqueous dispersion liquid of colorant fine particle | 75 parts by mass |
| aqueous dispersion liquid of release agent fine particle | 150 parts by mass |
| ion exchange water | 525 parts by mass |

The materials above were placed in a round stainless steel flask, and mixed. To this solution, an aqueous solution prepared by dissolving 1.5 parts by mass of magnesium sulfate in 148.5 parts by mass of ion exchange water was added. Using a homogenizer (made by IKA Works GmbH & Co. KG: ULTRA-TURRAXT50), the materials were dispersed at 5000 r/min for 10 minutes. Then, the obtained mixed solution was heated to 52° C. while the number of rotation was properly adjusted such that the mixed solution was stirred in a heating oil bath using a stirring blade. The solution was kept at 52° C. for 1 hour to form an aggregate particle. The volume average particle diameter of the formed aggregate particle was measured using a flow type particle image analyzer (made by Sysmex Corporation: FPIA-3000) according to the operation manual of the apparatus. As a result, the volume average particle diameter was approximately 5.3 μm.

### <Fusion Process>

An aqueous solution prepared by dissolving 15 parts by mass of trisodium citrate based on 285 parts by mass of ion exchange water was added to the dispersion liquid of the aggregate particle obtained in the aggregation process. Then, an aqueous solution prepared by dissolving 9.0 parts by mass of sodium chloride based on 141 parts by mass of ion exchange water was added. While the solution was continuously stirred, the solution was heated to 75° C., and kept at 75° C. for 2 hours. The volume average particle diameter and average circularity of the obtained particle were measured using a flow type particle image analyzer (made by Sysmex Corporation: FPIA-3000) according to the operation manual of the apparatus. As a result, it was found that a sufficiently fused and integrated particle whose volume average particle diameter was approximately 5.4 μm and average circularity was 0.963 was formed. Then, the filtrate was sufficiently washed with ion exchange water, and dried using a vacuum dryer to obtain Toner Particle 4.

Toner Particle 4 was measured by the Coulter Multisizer III (made by Beckman Coulter, Inc.). The weight-average particle diameter (D4) was 5.4 μm, and the number average particle diameter (D1) was 4.7 μm. Namely, D4/D1 was 1.15, and Toner Particle 4 had a sharp particle size distribution. The circularity of Toner Particle 4 was measured using a flow type particle image analyzer (made by Sysmex Corporation: FPIA-3000). The average circularity was 0.966.

### Example 5

Toner Particle 5 was obtained in the same manner as in Example 4 except that sodium chloride used in the fusion process was replaced by potassium chloride, and the heating time in the fusion process was changed to 3 hours. Toner Particle 5 had a weight-average particle diameter (D4) of 5.6 μm, D4/D1 of 1.15, and an average circularity of 0.961.

### Example 6

Toner Particle 6 was obtained in the same manner as in Example 4 except that sodium chloride used in the fusion process was replaced by sodium carbonate, and the heating time in the fusion process was changed to 4 hours. Toner Particle 6 had a weight-average particle diameter (D4) of 5.8 μm, D4/D1 of 1.15, and an average circularity of 0.961.

### Example 7

Toner Particle 7 was obtained in the same manner as in Example 4 except that trisodium citrate used in the fusion process was replaced by sodium ethylenediaminetetraacetate. Toner Particle 7 had a weight-average particle diameter (D4) of 5.6 μm, D4/D1 of 1.15, and an average circularity of 0.965.

### Example 8

Toner Particle 8 was obtained in the same manner as in Example 4 except that trisodium citrate in the fusion process was replaced by disodium succinate. Toner Particle had a weight-average particle diameter D4 of 5.9 μm, D4/D1 of 1.22, and an average circularity of 0.960.

### Example 9

### Aggregation Process

| | |
|---|---|
| aqueous dispersion liquid of Styrene-Acrylic Co- | 600 parts by mass |
| polymer A | |
| aqueous dispersion liquid of the colorant fine | 75 parts by mass |
| particle | |
| aqueous dispersion liquid of the release agent fine | 150 parts by mass |
| particle | |
| ion exchange water | 525 parts by mass |

The materials above were placed in a round stainless steel flask, and mixed. To this solution, an aqueous solution prepared by dissolving 1.5 parts by mass of magnesium sulfate in 148.5 parts by mass of ion exchange water was added. Using a homogenizer (made by IKA Works GmbH & Co. KG: ULTRA-TURRAXT50), the materials were dispersed at 5000 r/min for 10 minutes. Then, the obtained mixed solution was heated to 50° C. while the number of rotation was properly adjusted such that the mixed solution was stirred in a heating oil bath using a stirring blade. The solution was kept at 50° C. for 1 hour. Then, the volume average particle diameter of the formed aggregate particle was measured using a flow type particle image analyzer (made by Sysmex Corporation: FPIA-3000) according to the operation manual of the apparatus. As a result, it was found that an aggregate particle whose volume average particle diameter was approximately 5.2 μm was formed.

<Fusion Process>

An aqueous solution prepared by dissolving 15 parts by mass of trisodium citrate based on 285 parts by mass of ion exchange water was added to the dispersion liquid of the aggregate particle obtained in the aggregation process. Then, an aqueous solution prepared by dissolving 9 parts by mass of sodium chloride based on 141 parts by mass of ion exchange water was added. While the solution was continuously stirred, the solution was heated to 75° C., and kept at 75° C. for 3 hours. The volume average particle diameter and average circularity of the obtained particle were measured using a flow type particle image analyzer (made by Sysmex Corporation: FPIA-3000) according to the operation manual of the apparatus. As a result, it was found that a sufficiently fused and integrated particle whose volume average particle diameter was approximately 5.3 μm and average circularity was 0.966 was formed. Then, the filtrate was sufficiently washed with ion exchange water, and dried using a vacuum dryer to obtain Toner Particle 9.

Toner Particle 9 was measured by the Coulter Multisizer III (made by Beckman Coulter, Inc.). The weight-average particle diameter (D4) was 5.3 μm, and the number average particle diameter (D1) was 4.6 μm. Namely, D4/D1 was 1.15, and Toner Particle 9 had a sharp particle size distribution. The circularity of Toner Particle 9 was measured using a flow type particle image analyzer (made by Sysmex Corporation: FPIA-3000). The average circularity was 0.965.

### Example 10

### Aggregation Process

| | |
|---|---|
| aqueous dispersion liquid of Polyurethane Resin A | 600 parts by mass |
| aqueous dispersion liquid of the colorant fine | 75 parts by mass |
| particle | |
| aqueous dispersion liquid of the release agent fine | 150 parts by mass |
| particle | |
| ion exchange water | 475 parts by mass |

The materials above were placed in a round stainless steel flask, and mixed. To this solution, an aqueous solution prepared by dissolving 2 parts by mass of magnesium sulfate based on 198 parts by mass of ion exchange water was added. Using a homogenizer (made by IKA Works GmbH & Co. KG: ULTRA-TURRAXT50), the materials were dispersed at 5000 r/min for 10 minutes. Then, the obtained mixed solution was heated to 50° C. while the number of rotation was properly adjusted such that the mixed solution was stirred in a heating oil bath using a stirring blade. The solution was kept at 50° C. for 1 hour. Then, the volume average particle diameter of the formed aggregate particle was measured using a flow type particle image analyzer (made by Sysmex Corporation: FPIA-3000) according to the operation manual of the apparatus. As a result, it was found that an aggregate particle whose volume average particle diameter was approximately 5.5 μm was formed.

<Fusion Process>

An aqueous solution prepared by dissolving 15 parts by mass of trisodium citrate based on 285 parts by mass of ion exchange water was added to the dispersion liquid of the aggregate particle obtained in the aggregation process. Then, an aqueous solution prepared by dissolving 9 parts by mass of sodium chloride based on 141 parts by mass of ion exchange water was added. While the solution was continuously stirred, the solution was heated to 75° C., and kept at 75° C. for 3 hours. The volume average particle diameter and average circularity of the obtained particle were measured using a flow type particle image analyzer (made by Sysmex Corporation: FPIA-3000) according to the operation manual of the apparatus. As a result, it was found that a sufficiently fused and integrated particle whose volume average particle diameter was approximately 5.4 μm and average circularity was 0.965 was formed. Then, the filtrate was sufficiently washed with ion exchange water, and dried using a vacuum dryer to obtain Toner Particle 10.

Toner Particle 10 was measured by the Coulter Multisizer III (made by Beckman Coulter, Inc.). The weight-average particle diameter (D4) was 5.4 μm, and the number average particle diameter (D1) was 4.7 μm. Namely, D4/D1 was 1.15, and Toner Particle 10 had a sharp particle size distribution. The circularity of Toner Particle 10 was measured using a flow type particle image analyzer (made by Sysmex Corporation: FPIA-3000). The average circularity was 0.965.

As above, in the process for producing a toner that satisfies the requirements of the present invention, a toner particle having a small particle diameter, a sharp particle size distribution, and a properly controlled average circularity can be produced even if the temperature and the treatment time are reduced in the fusion process.

### Comparative Example 1

### Aggregation Process

| | |
|---|---|
| aqueous dispersion liquid of Polyester Resin A | 450 parts by mass |
| aqueous dispersion liquid of Polyester Resin B | 150 parts by mass |
| aqueous dispersion liquid of the colorant fine | 75 parts by mass |
| particle | |
| release agent aqueous dispersion liquid | 150 parts by mass |
| ion exchange water | 525 parts by mass |

The materials above were placed in a round stainless steel flask, and mixed. To this solution, an aqueous solution prepared by dissolving 1.5 parts by mass of magnesium sulfate based on 148.5 parts by mass of ion exchange water was added. Using a homogenizer (made by IKA Works GmbH & Co. KG: ULTRA-TURRAXT50), the materials were dispersed at 5000 r/min for 10 minutes. Then, the obtained mixed solution was heated to 52° C. while the number of rotation was properly adjusted such that the mixed solution was stirred in a heating oil bath using a stirring blade. The solution was kept at 52° C. for 1 hour. Then, the volume average particle diameter of the formed aggregate particle was measured using a flow type particle image analyzer (made by Sysmex Corporation: FPIA-3000) according to the operation manual of the apparatus. As a result, it was found that an aggregate particle whose volume average particle diameter was approximately 5.3 μm was formed.

<Fusion Process>

An aqueous solution prepared by dissolving 15 parts by mass of trisodium citrate based on 285 parts by mass of ion exchange water was added to the dispersion liquid of the aggregate particle obtained in the aggregation process. While the solution was continuously stirred, the solution was heated to 75° C., and kept at 75° C. for 12 hours. The volume average particle diameter and average circularity of the obtained particle were measured using a flow type particle image analyzer (made by Sysmex Corporation: FPIA-3000) according to the operation manual of the apparatus. As a result, it was found that the volume average particle diameter was approximately 5.4 μm, the average circularity was 0.891, and a sufficiently fused and integrated particle was not obtained. Then, a filtrate was sufficiently washed with ion exchange water, and dried using a vacuum dryer to obtain Comparative Toner Particle 1.

Comparative Toner Particle 1 was measured by the Coulter Multisizer III (made by Beckman Coulter, Inc.). The weight-average particle diameter (D4) was 5.5 μm, and the number average particle diameter (D1) was 4.8 μm. Namely, D4/D1 was 1.15, and Comparative Toner Particle 1 had a sharp particle size distribution. The circularity of Comparative Toner Particle 1 was measured using a flow type particle image analyzer (made by Sysmex Corporation: FPIA-3000). The average circularity was 0.887. As above, if the temperature was reduced on the neutral condition, the particle was not sufficiently fused and integrated even by a treatment for a long time, and the shape (circularity) of the toner could not be controlled.

### Comparative Example 2

### Aggregation Process

| | |
|---|---|
| aqueous dispersion liquid of Polyester Resin A | 450 parts by mass |
| aqueous dispersion liquid of Polyester Resin B | 150 parts by mass |
| aqueous dispersion liquid of the colorant fine | 75 parts by mass |
| particle | |
| aqueous dispersion liquid of the release agent fine | 150 parts by mass |
| particle | |
| ion exchange water | 525 parts by mass |

The components above were placed in a round stainless steel flask, and mixed. To this solution, an aqueous solution prepared by dissolving 1.5 parts by mass of magnesium sulfate based on 148.5 parts by mass of ion exchange water was added. Using a homogenizer (made by IKA Works GmbH & Co. KG: ULTRA-TURRAXT50), the components were dispersed at 5000 r/min for 10 minutes. Then, the obtained mixed solution was heated to 52° C. while the number of rotation was properly adjusted such that the mixed solution was stirred in a heating oil bath using a stirring blade. The solution was kept at 52° C. for 1 hour. Then, the volume average particle diameter of the formed aggregate particle was measured using a flow type particle image analyzer (made by Sysmex Corporation: FPIA-3000) according to the operation manual of the apparatus. As a result, it was found that an aggregate particle whose volume average particle diameter was approximately 5.3 μm was formed.

<Fusion Process>

An aqueous solution prepared by dissolving 9 parts by mass of sodium chloride based on 141 parts by mass of ion exchange water was added to the dispersion liquid of the aggregate particle obtained in the aggregation process. While the solution was continuously stirred, the solution was heated to 75° C., and kept at 75° C. for 1 hour. Then, the toner was further aggregated to produce a coarse particle (volume average particle diameter was approximately 13.4 μm).

As above, unless trisodium citrate as the chelating agent was added as a terminating agent, aggregation could not be terminated, and the toner became a coarse particle whose diameter was not less than 10 μm.

### Comparative Example 3

Comparative Toner Particle 3 was obtained (the weight-average particle diameter was 5.5 μm, D4/D1 was 1.15, and the average circularity was 0.885) in the same manner as in Comparative Example 1 except that the heating temperature in the fusion process was 95° C., and the temperature was kept for 0.5 hours.

### Comparative Example 4

Comparative Toner Particle 4 was obtained (the weight-average particle diameter was 5.5 μm, D4/D1 was 1.15, and the average circularity was 0.966) in the same manner as in Comparative Example 1 except that the heating temperature in the fusion process was 95° C., and the temperature was kept for 5 hours.

The configuration of the toner particle and condition of the fusion process in Toner Particles 1 to 10 according to Examples 1 to 10 and Comparative Toner Particles 1 to 4 according to Comparative Examples 1 to 4 are shown in Tables 1 and 2.

TABLE 1

| | | Resin | | |
|---|---|---|---|---|
| | | | | Glass transition |
| | Toner particle | Resin 1 | Resin 2 | temperature (° C.) |
| Example 1 | Toner particle 1 | Polyester resin A | — | 56 |
| Example 2 | Toner particle 2 | Polyester resin A | — | 56 |
| Example 3 | Toner particle 3 | Polyester resin B | — | 59 |
| Example 4 | Toner particle 4 | Polyester resin A | Polyester resin B | 57 |
| Example 5 | Toner particle 5 | Polyester resin A | Polyester resin B | 57 |
| Example 6 | Toner particle 6 | Polyester resin A | Polyester resin B | 57 |
| Example 7 | Toner particle 7 | Polyester resin A | Polyester resin B | 57 |
| Example 8 | Toner particle 8 | Polyester resin A | Polyester resin B | 57 |
| Example 9 | Toner particle 9 | Styrene-acrylic | — | 53 |
| | | copolymer A | | |
| Example 10 | Toner particle 10 | Polyurethane resin A | — | 55 |
| Comparative | Comparative | Polyester resin A | Polyester resin B | 57 |
| Example 1 | toner particle 1 | | | |
| Comparative | Comparative | Polyester resin A | Polyester resin B | 57 |
| Example 2 | toner particle 2 | | | |
| Comparative | Comparative | Polyester resin A | Polyester resin B | 57 |
| Example 3 | toner particle 3 | | | |
| Comparative | Comparative | Polyester resin A | Polyester resin B | 57 |
| Example 4 | toner particle 4 | | | |

TABLE 2

| | | Fusion process | | | | | Toner particle | | |
|---|---|---|---|---|---|---|---|---|---|
| | | | Metal | | Temperature | Time | D4 | | |
| | Toner particle | Chelating agent | salt | pH | (° C.) | (h) | (μm) | D4/D1 | Average circularity |
| Example 1 | Toner particle 1 | Trisodium citrate | NaCl | 7.7 | 75 | 2 | 5.4 | 1.15 | 0.965 |
| Example 2 | Toner particle 2 | Trisodium citrate | NaCl | 7.7 | 95 | 0.5 | 5.5 | 1.15 | 0.966 |
| Example 3 | Toner particle 3 | Trisodium citrate | NaCl | 7.7 | 75 | 3 | 5.7 | 1.15 | 0.959 |
| Example 4 | Toner particle 4 | Trisodium citrate | NaCl | 7.7 | 75 | 2 | 5.4 | 1.15 | 0.966 |
| Example 5 | Toner particle 5 | Trisodium citrate | KCl | 7.7 | 75 | 3 | 5.6 | 1.15 | 0.961 |
| Example 6 | Toner particle 6 | Trisodium citrate | Na₂CO₃ | 8.2 | 75 | 4 | 5.8 | 1.15 | 0.961 |
| Example 7 | Toner particle 7 | Sodium | NaCl | 8.6 | 75 | 2 | 5.6 | 1.15 | 0.965 |
| | | ethylenediaminetetraacetate | | | | | | | |
| Example 8 | Toner particle 8 | Disodium succinate | NaCl | 7.7 | 75 | 2 | 5.9 | 1.22 | 0.960 |
| Example 9 | Toner particle 9 | Trisodium citrate | NaCl | 7.7 | 75 | 3 | 5.3 | 1.15 | 0.965 |
| Example 10 | Toner particle 10 | Trisodium citrate | NaCl | 7.7 | 75 | 3 | 5.4 | 1.15 | 0.965 |
| Comparative | Comparative toner | Trisodium citrate | — | 7.7 | 75 | 12 | 5.5 | 1.15 | 0.887 |
| Example 1 | particle 1 | | | | | | | | |
| Comparative | Comparative toner | — | NaCl | 7.0 | 75 | 1 | Aggregation could not be terminated | | |
| Example 2 | particle 2 | | | | | | | | |
| Comparative | Comparative toner | Trisodium citrate | — | 7.7 | 95 | 0.5 | 5.5 | 1.15 | 0.885 |
| Example 3 | particle 3 | | | | | | | | |
| Comparative | Comparative toner | Trisodium citrate | — | 7.7 | 95 | 5 | 5.5 | 1.15 | 0.966 |
| Example 4 | particle 4 | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-236690, filed Oct. 28, 2011, which is hereby incorporated by reference herein in its entirety.

What is claimed is:

1. A process for producing a toner, comprising the steps of:
(I) mixing
an aqueous dispersion liquid in which resin fine particles each containing a resin having an acidic polar group are dispersed, with
an aqueous dispersion liquid in which colorant fine particles each containing a colorant are dispersed, to obtain a mixed dispersion liquid containing the resin fine particles and the colorant fine particles;
(II) aggregating the resin fine particles and the colorant fine particles to form aggregate particles by adding an aggregating agent containing a divalent or higher-valent metal ion to the mixed dispersion liquid; and
(III) fusing the resin fine particles and the colorant fine particles in the aggregate particles by
(a) adding a chelating agent to a dispersion liquid of the aggregate particles, and then adding a monovalent water-soluble metal salt thereto, and
(b) heating at a temperature of not less than a glass transition temperature of the resin having an acidic polar group.

2. The process for producing a toner according to claim 1, wherein the monovalent water-soluble metal salt is a neutral salt.

3. The process for producing a toner according to claim 1, wherein the monovalent water-soluble metal salt is selected from the group consisting of sodium chloride, sodium sulfate, potassium chloride, and sodium carbonate.

4. The process for producing a toner according to claim 1, wherein the chelating agent is a metal salt of a trivalent or higher-valent carboxylic acid.

5. The process for producing a toner according to claim 1, wherein the resin having an acidic polar group is a polyester resin.

6. The process for producing a toner according to claim 1, wherein the acidic polar group is selected from the group consisting of a carboxyl group, a sulfonic acid group, a phosphonic acid group, and a sulfinic acid group.

7. The process for producing a toner according to claim 1, wherein an acid value of the resin having an acidic polar group is 5 to 50 mgKOH/g.
